(19) United States
(12) Patent Application Publication
(10) Pub. No.: US 2013/0069908 A1
(43) Pub. Date: Mar. 21, 2013

(54) Capacitive Card for a Capacitive Touch Screen

(71) Applicant: Mei-Jung Sung, Taichung City (TW)

(72) Inventor: Mei-Jung Sung, Taichung City (TW)

(21) Appl. No.: 13/606,064

(22) Filed: Sep. 7, 2012

(30) Foreign Application Priority Data
Sep. 19, 2011 (TW) 100217652

(51) Int. Cl. G06F 3/044

(52) U.S. Cl. 345/174

(57) ABSTRACT

A capacitive card for a capacitive touch screen has a substrate and a capacitive layer. The substrate has a surface. The capacitive layer is securely formed on the surface of the substrate and has multiple capacitive electrode areas and at least one circuit connected with the capacitive electrode areas. Because the capacitive card in accordance with the present invention is capacitive, the capacitive touch screen can read the configuration of the capacitive electrode areas and execute a specific program.

### BACKGROUND OF THE INVENTION

1. Field of the Invention

The present invention relates to a capacitive card for a capacitive touch screen, and more particularly to a capacitive card that can be read by a capacitive touch screen.

2. Description of Related Art

A conventional card, such as a personal identification number card, a poker card, a playing card, a flash card, a vocabulary card or an access card, is made of paper or plastic, but is not capacitive and cannot be detected or read by a capacitive touch screen of a smart phone.

Some conventional cards are printed with magnetic powders for being read by a magnetic head, but still cannot be read by the capacitive touch screen. Another kind of conventional card has an embedded RFID chip for being read by a specified reader but still cannot be read by the capacitive touch screen.

A portable electronic device, such as an iPhone, an iPad, a smart phone or a tablet, usually has a capacitive touch screen and has been widely used. If the portable electronic device can be used as a reader, the portable electronic device will be convenient for users and save a cost of purchasing an extra reader.

In addition, private personal information is often stored in the portable electronic device. Accordingly, protecting the information in the portable electronic device is greatly important. If the capacitive touch screen of a portable electronic device can function as a reader, said touch screen will be able to verify a password to safeguard information.

To overcome the shortcomings, the present invention tends to provide a capacitive card for an electric capacitive touch screen to mitigate the aforementioned problems.

### SUMMARY OF THE INVENTION

The main objective of the invention is to provide a capacitive card for a capacitive touch screen that can be read by a capacitive touch screen.

A capacitive card for a capacitive touch screen has a substrate and a capacitive layer. The substrate has a surface. The capacitive layer is securely formed on the surface of the substrate and has multiple capacitive electrode areas and at least one circuit connected with the capacitive electrode areas. Because the capacitive card in accordance with the present invention is capacitive, the capacitive touch screen can read the configuration of the capacitive electrode areas and execute a specific program.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a capacitive card for a capacitive touch screen in accordance with the present invention;

FIG. 2 is an operational perspective view of the capacitive card in FIG. 1;

FIG. 3 is an operational perspective view of the capacitive card in FIG. 2 showing that the capacitive card is read by a capacitive touch screen of a smart phone;

FIG. 4 is a top view of a second embodiment of a capacitive card in accordance with the present invention;

FIG. 5 is a top view of a third embodiment of a capacitive card in accordance with the present invention;

FIG. 6 is a top view of a fourth embodiment of a capacitive card in accordance with the present invention;

FIG. 7 is an exploded perspective view of a fifth embodiment of a capacitive card in accordance with the present invention;

FIG. 8 is an exploded perspective view of a sixth embodiment of a capacitive card in accordance with the present invention;

FIG. 9 is an exploded perspective view of a seventh embodiment of a capacitive card in accordance with the present invention;

FIG. 10 is a bottom view of an eighth embodiment of a capacitive card in accordance with the present invention;

FIG. 11 is a bottom view of a ninth embodiment of a capacitive card in accordance with the present invention;

FIG. 12 is an exploded perspective view of a tenth embodiment of a capacitive card in accordance with the present invention; and

FIG. 13 is a cross sectional side view of an eleventh embodiment of a capacitive card in accordance with the present invention.

### DETAILED DESCRIPTION OF PREFERRED EMBODIMENT

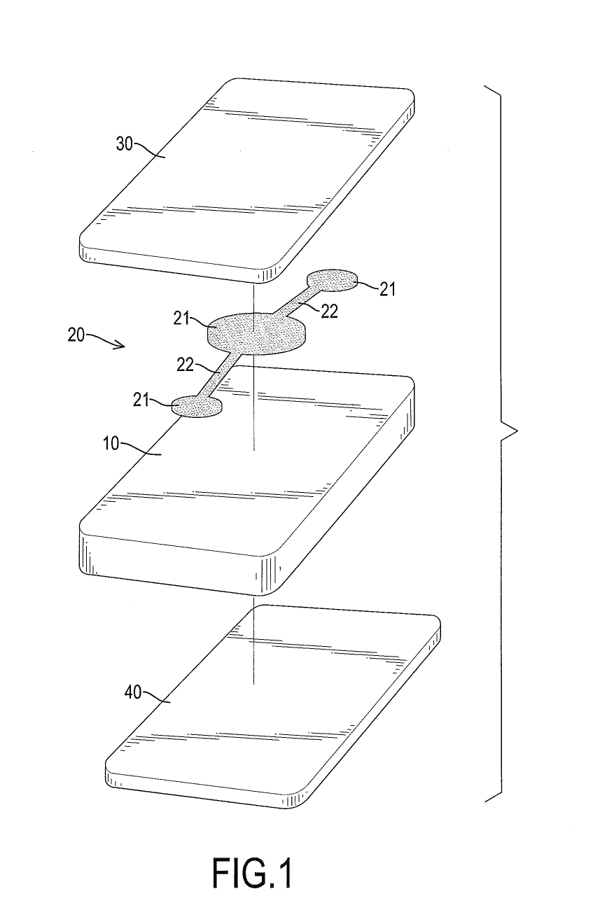

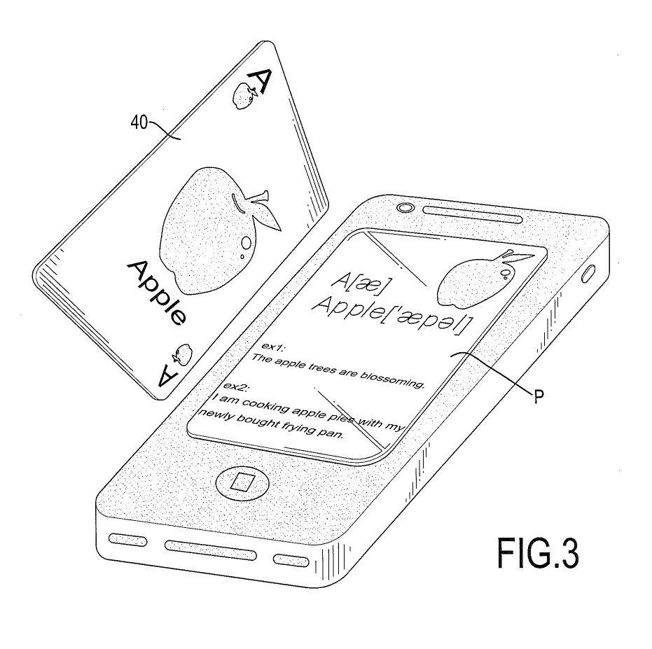

With reference to FIGS. 1 to 3, a first embodiment of a capacitive card for a capacitive touch screen in accordance with the present invention comprises a substrate 10, a capacitive layer 20, a first decorative cover 30 and a second decorative cover 40.

The substrate 10 has a surface. The substrate 10 may be opaque or made of transparent material, such as glass or plastic. Accordingly, the substrate 10 may serve as a transparent tape or a laminated film, which can be attached on a playing card, a credit card, a photo or any product.

The capacitive layer 20 is securely mounted on the surface of the substrate 10, is electrically conductive, and has multiple capacitive electrode areas 21 and multiple circuits 22. The shape of each electrode area 21 may be round, elliptic, square or rectangular. Preferably, three capacitive electrode areas 21 and two circuits 22 are implemented. Each circuit 22 is connected with two of the capacitive electrode areas 21 of the capacitive layer 20.

Preferably, one of the capacitive electrode areas 21 that is located between the other two capacitive electrode areas 21 is at least 4 square millimeters.

The capacitive layer 20 may be opaque or transparent. The capacitive electrode areas 21 may be made of ITO (Indium Tin Oxide), IZO (Indium Zinc Oxide), CR (Chrome), Chrome Oxide, ZnO, TiO, Cu (Copper), Fe (Iron), Al (Aluminum), or Ag Fiber. The capacitive layer 20 may have transparent conducting films.

The material of the circuits 22 may be the same as that of the capacitive electrode areas 21, or the material of the capacitive electrode areas 21 has a higher electric resistance than that of the circuits 22.

The first decorative cover 30 is securely mounted on the surface of the substrate 10 and covers the capacitive layer 20.

The second decorative cover 40 is securely mounted on the substrate 10 and is opposite to the capacitive layer 20.

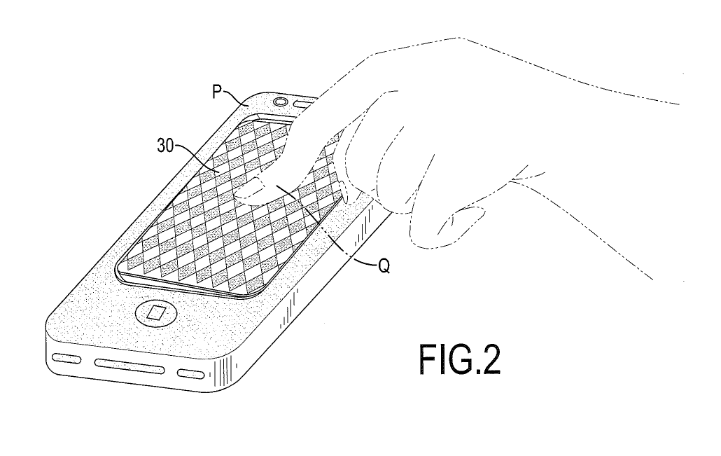

With reference to FIG. 2, the capacitive card is abutted by a finger Q onto a capacitive touch screen of a smart phone P. The finger Q triggers and activates one of the capacitive electrode areas 21 when the finger Q presses the capacitive electrode area 21. With the circuits 22, all of the capacitive electrode areas 21 are accordingly activated and amplified. Therefore, the capacitive touch screen of the smart phone P can read the configuration of the activated capacitive electrode areas 21. With the information of the configuration of the capacitive electrode areas 21, the smart phone P can execute a specific program, such as a photo viewer, or show specific information, or play a video file.

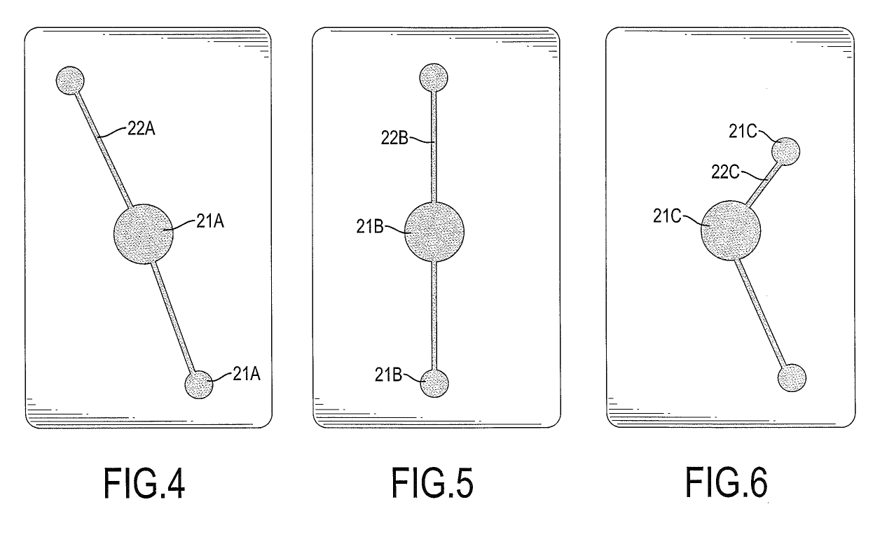

With reference to FIGS. 4 to 6, second, third and fourth embodiments of the capacitive card in accordance with the present invention are substantially the same as the first embodiment. The capacitive electrode areas 21A,21B,21C and the circuits 22A,22B,22C are arranged at different positions. Accordingly, the different configurations of the capacitive electrode areas 21A,21B,21C and the circuits 22A,22B,22C represent different commands or information that the capacitive touch screen can read.

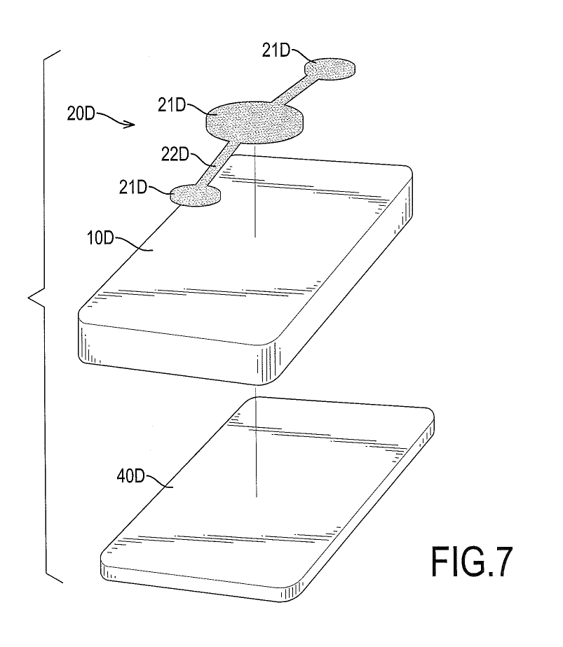

With reference to FIG. 7, a fifth embodiment of the capacitive card for a capacitive touch screen in accordance with the present invention is substantially the same as the first embodiment except the first decorative cover 30 is removed. Accordingly, the fifth embodiment has a substrate 10D, a capacitive layer 20D and a second decorative cover 40D. The capacitive layer 20D has multiple capacitive electrode areas 21D and multiple circuits 22D. Accordingly, the finger Q can directly touch and activate one of the capacitive electrode areas 21D.

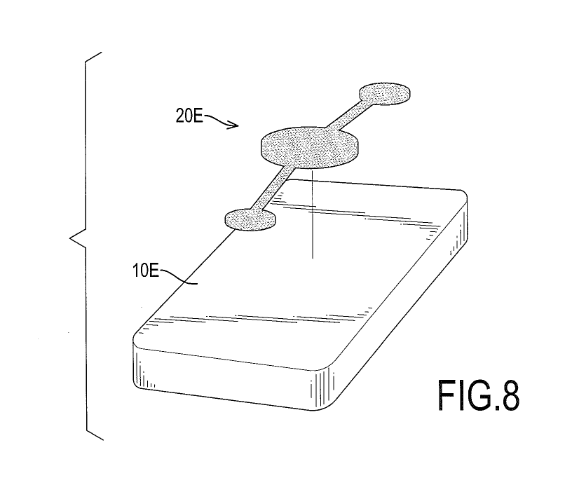

With reference to FIG. 8, a sixth embodiment of the capacitive card for a capacitive touch screen in accordance with the present invention is substantially the same as the first embodiment except the first decorative cover 30 and the second decorative cover 40 are removed. Accordingly, the sixth embodiment has a substrate 10E and a capacitive layer 20E.

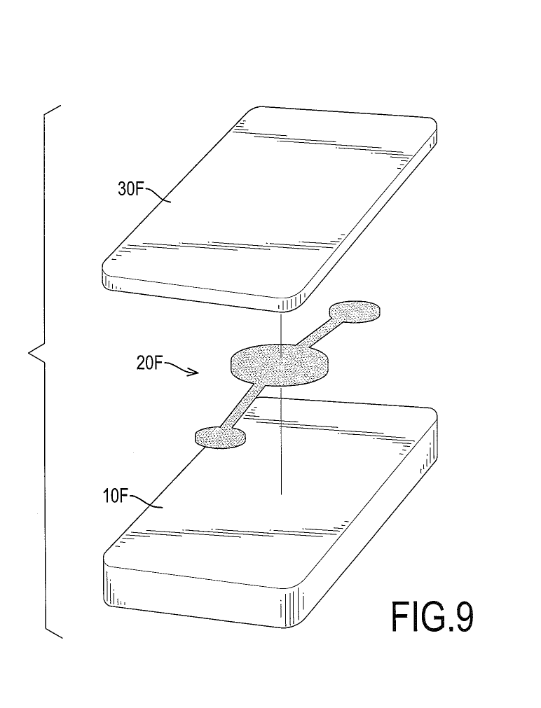

With reference to FIG. 9, a seventh embodiment of the capacitive card for a capacitive touch screen in accordance with the present invention is substantially the same as the first embodiment except the second decorative cover 40 is removed. Accordingly, the fifth embodiment has a substrate 10F, a capacitive layer 20F and a first decorative cover 30F.

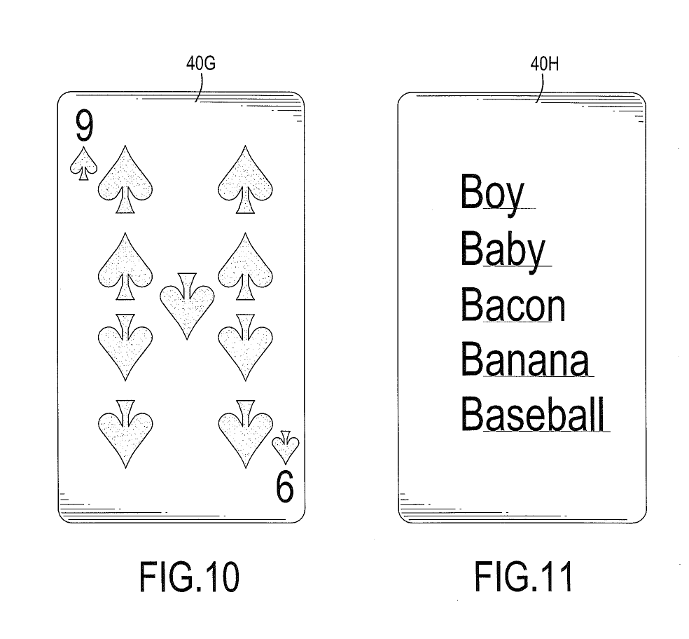

With reference to FIG. 10, an eighth embodiment of the capacitive card is substantially the same as the first embodiment. The second decorative cover 40G has a poker pattern. With reference to FIG. 11, a ninth embodiment of the capacitive card is substantially the same as the first embodiment. The second decorative cover 40H has a pattern with vocabulary entries.

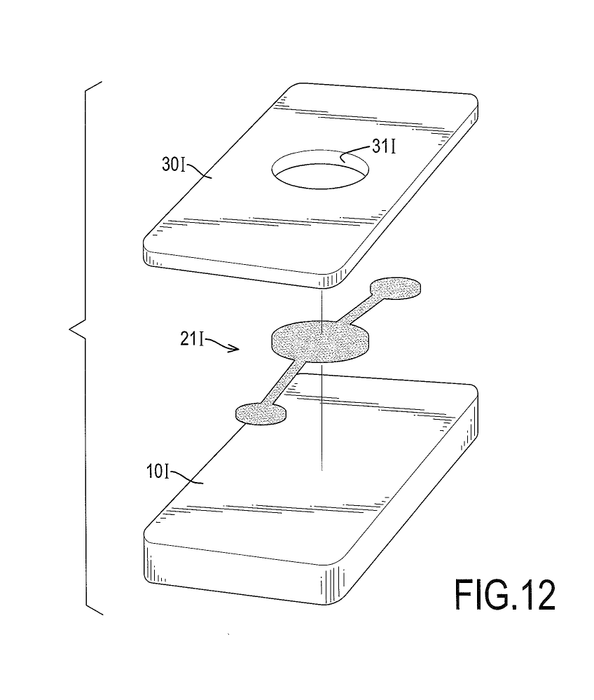

With reference to FIG. 12, a tenth embodiment of the capacitive card is substantially the same as the first embodiment. The first decorative cover 30I has a through hole 31I formed through a central area of the first decorative cover 30I. The finger Q can directly touch and activate the central one of the capacitive electrode areas 21I.

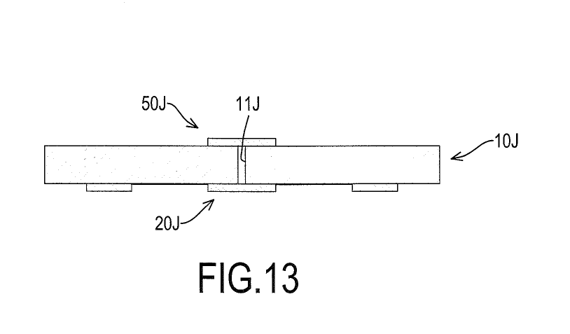

With reference to FIG. 13, an eleventh embodiment of the capacitive card is substantially the same as the first embodiment. The eleventh embodiment further has a capacitive sheet 50J. The capacitive sheet 50J is securely mounted on the substrate 10J, is opposite to the capacitive layer 20J, and has a capacitive electrode area.

Because the substrate 10J is thin, the capacitive sheet 50J activates the capacitive layer 20J when the capacitive sheet 50J is directly touched by the finger Q. Preferably, the substrate 10J has an aperture 11J formed through the substrate 10J and having an electrically conductive inner surface. Accordingly, the capacitive sheet 50J may activate the capacitive layer 20J via the electrically conductive inner surface of the aperture 11J.

From the above description, it is noted that the present invention has the following advantage:

Because the capacitive card in accordance with the present invention is capacitive, the capacitive touch screen can read the configuration of the capacitive electrode areas 21 and execute a specific program. Accordingly, the capacitive card is convenient in use and the user does not have to purchase an extra reader. With different configurations of the capacitive layer 20 and the second decorative cover 40 having different patterns, the capacitive card can serve as a personal identification number card, a poker card, a playing card, a flash card, a vocabulary card or an access card.

Even though numerous characteristics and advantages of the present invention have been set forth in the foregoing description, together with details of the structure and function of the invention, the disclosure is illustrative only, and changes may be made in detail, especially in matters of shape, material, size, and arrangement of parts within the principles of the invention to the full extent indicated by the broad general meaning of the terms in which the appended claims are expressed.

What is claimed is:

1. A capacitive card for a capacitive touch screen, the capacitive card comprising:
a substrate having a surface; and
a capacitive layer being electrically conductive, securely mounted on the surface of the substrate and having:
multiple capacitive electrode areas; and
at least one circuit connected with the capacitive electrode areas of the capacitive layer, such that the capacitive electrode areas are electrically connected by the at least one circuit.

2. The capacitive card for a capacitive touch screen as claimed in claim 1, wherein the capacitive card has a first decorative cover securely mounted on the surface of the substrate and covering the capacitive layer.

3. The capacitive card for a capacitive touch screen as claimed in claim 1, wherein the capacitive card has a second decorative cover securely mounted on the substrate and opposite to the capacitive layer.

4. The capacitive card for a capacitive touch screen as claimed in claim 2, wherein the capacitive card has a second decorative cover securely mounted on the substrate and opposite to the capacitive layer.

5. The capacitive card for a capacitive touch screen as claimed in claim 2, wherein the first decorative cover has a through hole formed through a central area of the first decorative cover.

6. The capacitive card for a capacitive touch screen as claimed in claim 4, wherein the first decorative cover has a through hole formed through a central area of the first decorative cover.

7. The capacitive card for a capacitive touch screen as claimed in claim 1, wherein the capacitive card has
a capacitive sheet securely mounted on the substrate, opposite to the capacitive layer, and having a capacitive electrode area.

8. The capacitive card for a capacitive touch screen as claimed in claim 2, wherein the capacitive card has
a capacitive sheet securely mounted on the substrate, opposite to the capacitive layer, and having a capacitive electrode area.

9. The capacitive card for a capacitive touch screen as claimed in claim 1, wherein the capacitive layer and the substrate are transparent.

10. The capacitive card for a capacitive touch screen as claimed in claim 3, wherein the second decorative cover has a pattern opposite to the substrate.

11. The capacitive card for a capacitive touch screen as claimed in claim 1, wherein material of the at least one circuit is the same as that of the capacitive electrode areas.

12. The capacitive card for a capacitive touch screen as claimed in claim 1, wherein material of the capacitive electrode areas has a higher electric resistance than that of the least one circuit.

13. The capacitive card for a capacitive touch screen as claimed in claim 1, wherein one of the capacitive electrode areas is at least 4 square millimeters.
